(19) United States
(12) Patent Application Publication
(10) Pub. No.: US 2012/0236448 A1
(43) Pub. Date: Sep. 20, 2012

(54) SEMICONDUCTOR INTEGRATED CIRCUIT

(75) Inventor: Takayuki Hiraoka, Kanagawa (JP)

(73) Assignee: KABUSHIKI KAISHA TOSHIBA, Tokyo (JP)

(21) Appl. No.: 13/238,639

(22) Filed: Sep. 21, 2011

(30) Foreign Application Priority Data
Mar. 16, 2011 (JP) 2011-058015

(51) Int. Cl. H02H 9/04

(52) U.S. Cl. 361/56

(57) ABSTRACT

According to one embodiment, a first electrostatic protection circuit is connected between a first power supply wire and a second power supply wire, a second electrostatic protection circuit is connected between the first power supply wire and a third power supply wire, a first transistor is connected between the second power supply wire and the third power supply wire, a gate control circuit controls a gate potential of the first transistor based on a detection result of a second voltage, a second transistor is connected between the third power supply wire and a gate of the first transistor, and an abnormal voltage detection circuit controls on and off of the second transistor based on a detection result of a third voltage.

### CROSS-REFERENCE TO RELATED APPLICATIONS

This application is based upon and claims the benefit of priority from the prior Japanese Patent Application No. 2011-58015, filed on Mar. 16, 2011; the entire contents of which are incorporated herein by reference.

### FIELD

Embodiments described herein relate generally to a semiconductor integrated circuit.

### BACKGROUND

On some semiconductor devices, a regulator that generates a low potential output from a high potential input is mounted. In this regulator, a P-channel field-effect transistor is used for generating a low potential output from a high potential input and a gate potential thereof is feedback controlled for stabilizing a low potential power supply.

As a measure against an ESD (Electrostatic Discharge) of such a P-channel field-effect transistor, there is a method of inserting a silicide block into a drain layer. With this method, the layout area increases with the increase of the perimeter of the P-channel field-effect transistor, and when the perimeter of the P-channel field-effect transistor reaches tens of thousands of um, the layout area increases substantially.

### BRIEF DESCRIPTION OF THE DRAWINGS

FIG. 1 is a block diagram illustrating a schematic configuration of a voltage conversion circuit according to a first embodiment;

FIG. 2 is a diagram illustrating current-voltage characteristics of electrostatic protection circuits in FIG. 1;

FIG. 3 is a diagram illustrating the time variation of clamp voltage waveforms of the electrostatic protection circuits in FIG. 1;

FIG. 4 is a circuit diagram illustrating a configuration example of an abnormal voltage detection circuit in FIG. 1;

FIG. 5 is a diagram illustrating input-output characteristics of the abnormal voltage detection circuit in FIG. 4;

FIG. 6 is a block diagram illustrating a schematic configuration of a voltage conversion circuit according to a second embodiment;

FIG. 7 is a block diagram illustrating a schematic configuration of a voltage conversion circuit according to a third embodiment;

FIG. 8 is a circuit diagram illustrating a configuration example of an abnormal voltage detection circuit in FIG. 7; and

FIG. 9 is a block diagram illustrating a schematic configuration of a voltage conversion circuit according to a fourth embodiment.

### DETAILED DESCRIPTION

In general, according to a semiconductor integrated circuit of embodiments, the first power supply wire, the second power supply wire, the third power supply wire, the first electrostatic protection circuit, the second electrostatic protection circuit, the first transistor, the gate control circuit, the second transistor, and the abnormal voltage detection circuit are provided. The first power supply wire transmits a first voltage. The second power supply wire transmits a second voltage higher than the first voltage. The third power supply wire transmits a third voltage higher than the second voltage. The first electrostatic protection circuit is connected between the first power supply wire and the second power supply wire. The second electrostatic protection circuit is connected between the first power supply wire and the third power supply wire. The first transistor is connected between the second power supply wire and the third power supply wire. The gate control circuit controls a gate potential of the first transistor based on a detection result of the second voltage. The second transistor is connected between the third power supply wire and a gate of the first transistor. The abnormal voltage detection circuit controls on and off of the second transistor based on a detection result of the third voltage.

Exemplary embodiments of a semiconductor integrated circuit will be explained below with reference to the drawings. The present invention is not limited to these embodiments.

### First Embodiment

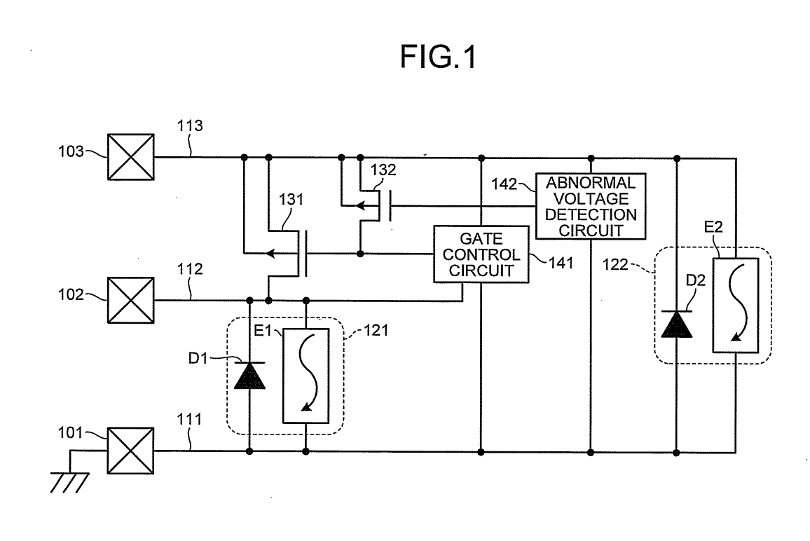

FIG. 1 is a block diagram illustrating a schematic configuration of a voltage conversion circuit according to the first embodiment.

In FIG. 1, a power supply wire 111 that transmits a first voltage V1 is connected to a pad electrode 101, a power supply wire 112 that transmits a second voltage V2 is connected to a pad electrode 102, and a power supply wire 113 that transmits a third voltage V3 is connected to a pad electrode 103. The second voltage V2 can be set to be higher than the first voltage V1 and the third voltage V3 can be set to be higher than the second voltage V2. For example, it is possible to set the first voltage V1 to a ground potential, the second voltage V2 to 1.2 V, and the third voltage V3 to 3.3 V.

An electrostatic protection circuit 121 is connected between the power supply wires 111 and 112 and an electrostatic protection circuit 122 is connected between the power supply wires 111 and 113. The clamp voltage of the electrostatic protection circuit 122 can be higher than the clamp voltage of the electrostatic protection circuit 121. The electrostatic protection circuit 121 includes a diode D1 and an electrostatic protection element El and the electrostatic protection circuit 122 includes a diode D2 and an electrostatic protection element E2. The polarities responding to an overcurrent can be made different from each other between the diodes D1 and D2 and the electrostatic protection elements E1 and E2. As the electrostatic protection elements E1 and E2, for example, cascade-connected diodes or a gg-nMOS (gate grounded nMOS) can be used. The diode D1 and the electrostatic protection element E1 are connected between the power supply wires 111 and 112 and the diode D2 and the electrostatic protection element E2 are connected between the power supply wires 111 and 113.

A P-channel field-effect transistor 131 is connected between power supply wires 112 and 113 and a P-channel field-effect transistor 132 is connected between the power supply wire 113 and the gate of the P-channel field-effect transistor 131. A gate control circuit 141 is connected to the gate of the P-channel field-effect transistor 131 and an abnormal voltage detection circuit 142 is connected to the gate of the P-channel field-effect transistor 132.

The gate control circuit 141 can control the gate potential of the P-channel field-effect transistor 131 based on the detection result of the second voltage V2. The abnormal voltage detection circuit 142 can control on and off of the P-channel field-effect transistor 132 based on the potential difference between the first voltage V1 and the third voltage V3.

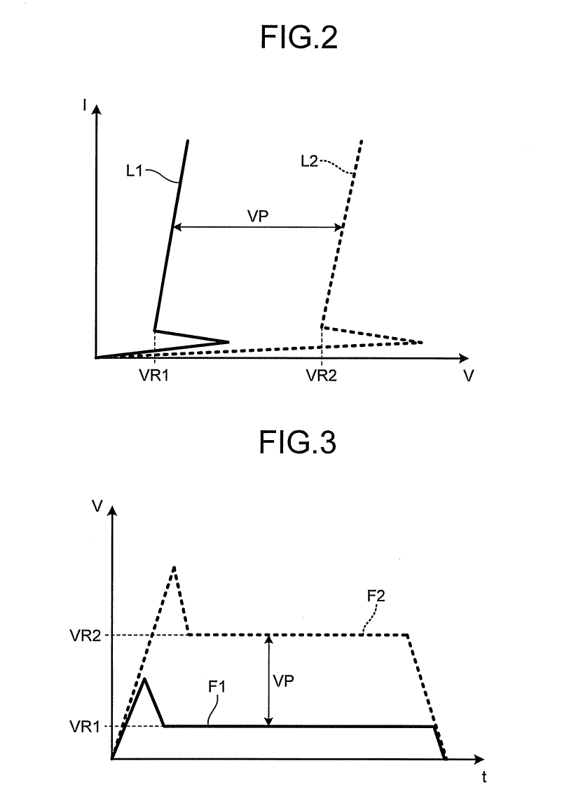

FIG. 2 is a diagram illustrating current-voltage characteristics of the electrostatic protection circuits in FIG. 1 and FIG. 3 is a diagram illustrating the time variation of the clamp voltage waveforms of the electrostatic protection circuits in FIG. 1. In FIG. 2, L1 indicates the current-voltage characteristics of the electrostatic protection circuit 121 in FIG. 1 and L2 indicates the current-voltage characteristics of the electrostatic protection circuit 122 in FIG. 1. In FIG. 3, F1 indicates the clamp voltage waveform of the electrostatic protection circuit 121 in FIG. 1 and F2 indicates the clamp voltage waveform of the electrostatic protection circuit 122 in FIG. 1.

In FIG. 2 and FIG. 3, a clamp voltage VR2 of the electrostatic protection circuit 122 is higher than a clamp voltage VR1 of the electrostatic protection circuit 121. Therefore, at the time of operation of the electrostatic protection circuits 121 and 122, an overvoltage VP corresponding to the clamp voltage difference VR2−VR1 between the electrostatic protection circuits 121 and 122 is applied to the P-channel field-effect transistor 131.

Then, in FIG. 1, the voltage between the power supply wires 111 and 112 is monitored by the electrostatic protection circuit 121, and when an overvoltage is applied between the power supply wires 111 and 112, the electrostatic protection circuit 121 operates, so that the voltage between the power supply wires 111 and 112 is clamped to the clamp voltage VR1.

The voltage between the power supply wires 111 and 113 is monitored by the electrostatic protection circuit 122, and when an overvoltage is applied between the power supply wires 111 and 113, the electrostatic protection circuit 122 operates, so that the voltage between the power supply wires 111 and 113 is clamped to the clamp voltage VR2.

The voltage between the power supply wires 111 and 113 is monitored by the abnormal voltage detection circuit 142. When the voltage between the power supply wires 111 and 113 is equal to or lower than a reference voltage, the gate potential of the P-channel field-effect transistor 132 is maintained in a high level. Therefore, the P-channel field-effect transistor 132 is turned off, so that the gate and the source of the P-channel field-effect transistor 131 are separated. On the other hand, when the voltage between the power supply wires 111 and 113 exceeds the reference voltage, the gate potential of the P-channel field-effect transistor 132 is maintained in a low level. Therefore, the P-channel field-effect transistor 132 is turned on and the gate and the source of the P-channel field-effect transistor 131 are short-circuited.

The reference voltage of the abnormal voltage detection circuit 142 can be set to be larger than the third voltage V3 (for example, 3.3 V) in a steady state and smaller than the turn-on voltage of the P-channel field-effect transistor 131.

Therefore, even when an overvoltage is input between the power supply wires 111 and 113, the gate and the source of the P-channel field-effect transistor 131 can be short-circuited before reaching the turn-on voltage of the P-channel field-effect transistor 131. The turn-on voltage of a field-effect transistor depends on a voltage between a gate and a source and typically becomes the highest at the time of gate-off (voltage between the gate and the source is zero). Therefore, the turn-on voltage of the P-channel field-effect transistor 131 is high, so that even when the clamp voltage difference VR2−VR1 between the electrostatic protection circuits 121 and 122 becomes large, snapback can be prevented until the turn-on voltage of the P-channel field-effect transistor 131 at the time of gate-off. Consequently, even when the overvoltage VP is applied to the P-channel field-effect transistor 131, breakdown of the P-channel field-effect transistor 131 can be suppressed without inserting a silicide block into the drain layer of the P-channel field-effect transistor 131, so that the ESD resistance of the P-channel field-effect transistor 131 can be improved while suppressing increase in the layout area.

For example, with the method of inserting a silicide block into the drain layer of the P-channel field-effect transistor 131 for improving the ESD resistance of the P-channel field-effect transistor 131, if the distance between the gate and the drain contact of the P-channel field-effect transistor 131 in the case of no silicide block inserted is defined as X, when a silicide block is inserted, the distance between the gate and the drain contact of the P-channel field-effect transistor 131 becomes about (2/0.12)X as one design example. Therefore, with the method of inserting a silicide block into the drain layer of the P-channel field-effect transistor 131, when the perimeter of the P-channel field-effect transistor 131 reaches tens of thousands of um, the layout area increases substantially.

On the contrary, with the method of setting the gate/source voltage of the P-channel field-effect transistor 131 to 0 V before the overvoltage VP is applied to the P-channel field-effect transistor 131, the ESD resistance can be improved without inserting a silicide block into the drain layer of the P-channel field-effect transistor 131, so that increase in the layout area can be suppressed.

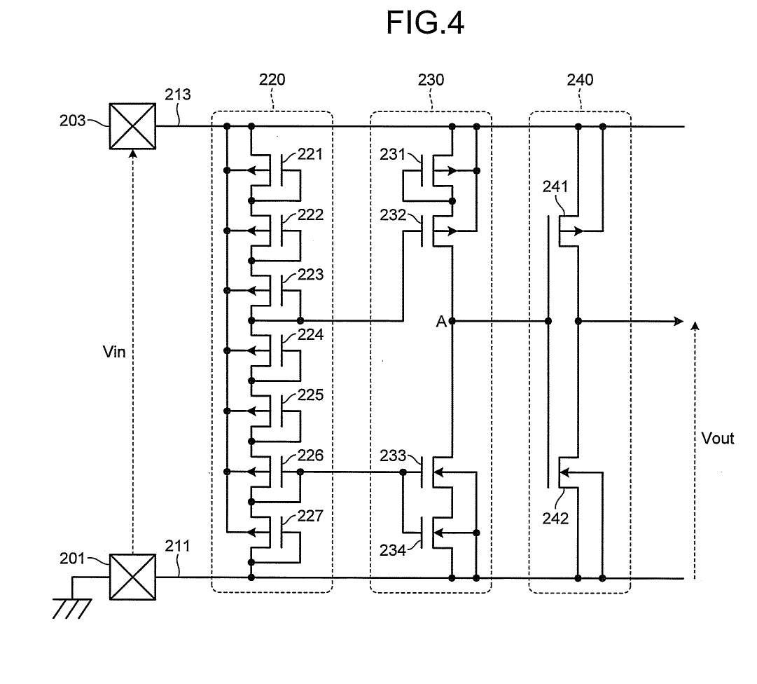

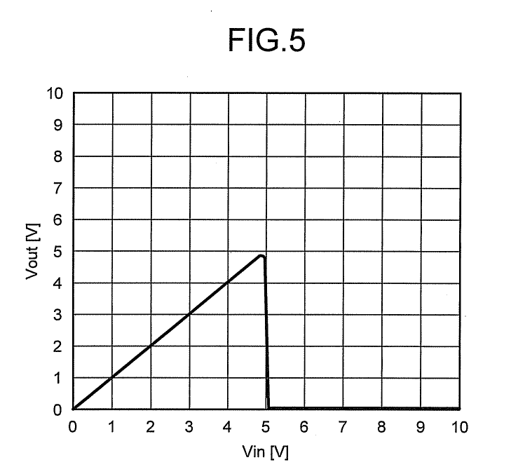

FIG. 4 is a circuit diagram illustrating a configuration example of the abnormal voltage detection circuit in FIG. 1 and FIG. 5 is a diagram illustrating input-output characteristics of the abnormal voltage detection circuit in FIG. 4.

In FIG. 4, the abnormal voltage detection circuit 142 includes a reference voltage generating circuit 220, an overvoltage detection circuit 230, and an output buffer 240. The reference voltage generating circuit 220 can generate a reference voltage by dividing the third voltage V3. The overvoltage detection circuit 230 can detect an overvoltage based on the reference voltage generated by the reference voltage generating circuit 220. The output buffer 240 can invert the output of the overvoltage detection circuit 230.

The reference voltage generating circuit 220, the overvoltage detection circuit 230, and the output buffer 240 are connected between power supply wires 211 and 213. A pad electrode 201 is connected to the power supply wire 211 and a pad electrode 203 is connected to the power supply wire 213. The power supply wire 211 can transmit the first voltage V1 and the power supply wire 213 can transmit the third voltage V3.

Specifically, the reference voltage generating circuit 220 includes P-channel field-effect transistors 221 to 227. Each of the P-channel field-effect transistors 221 to 227 is diode-connected by its own gate being connected to the drain. The diode-connected P-channel field-effect transistors 221 to 227 are connected in series. The source of the P-channel field-effect transistor 221 of the first stage is connected to the power supply wire 213 and the source of the P-channel field-effect transistor 227 of the last stage is connected to the power supply wire 211.

The overvoltage detection circuit 230 includes P-channel field-effect transistors 231 and 232 and N-channel field-effect transistors 233 and 234. The P-channel field-effect transistor 231 is diode-connected by its own gate being connected to the drain. The P-channel field-effect transistors 231 and 232 and the N-channel field-effect transistors 233 and 234 are connected in series. The source of the P-channel field-effect transistor 231 is connected to the power supply wire 213 and the source of the N-channel field-effect transistor 234 is connected to the power supply wire 211. The gate of the P-channel field-effect transistor 232 is connected to the drain of the P-channel field-effect transistor 223 of the third stage. The gates of the N-channel field-effect transistors 233 and 234 are connected to the drain of the P-channel field-effect transistor 226 of the sixth stage.

The output buffer 240 includes a P-channel field-effect transistor 241 and an N-channel field-effect transistor 242. The P-channel field-effect transistor 241 and the N-channel field-effect transistor 242 are connected in series. The source of the P-channel field-effect transistor 241 is connected to the power supply wire 213 and the source of the N-channel field-effect transistor 242 is connected to the power supply wire 211. The gates of the P-channel field-effect transistor 241 and the N-channel field-effect transistor 242 are connected to a connection point A of the P-channel field-effect transistor 232 and the N-channel field-effect transistor 233.

The driving force of the P-channel field-effect transistors 231 and 232 can be made larger than that of the N-channel field-effect transistors 233 and 234. The driving force of the P-channel field-effect transistor 241 can be made larger than that of the N-channel field-effect transistor 242. For example, the gate width of the P-channel field-effect transistors 221 to 227 and the N-channel field-effect transistors 233, 234, and 242 can be set to 1 μm, the gate width of the P-channel field-effect transistor 241 can be set to 2 μm, the gate width of the P-channel field-effect transistor 231 can be set to 10 μm, and the gate width of the P-channel field-effect transistor 232 can be set to 20 μm.

An input voltage Vin between the power supply wires 211 and 213 is sequentially divided in the P-channel field-effect transistors 221 to 227, and the divided voltage of the third stage is applied to the gate of the P-channel field-effect transistor 232 and the divided voltage of the sixth stage is applied to the gates of the N-channel field-effect transistors 233 and 234.

When the input voltage Vin is a steady voltage (for example, 3.3 V), the gate potential of the P-channel field-effect transistor 232 does not decrease sufficiently with respect to the source potential, so that the P-channel field-effect transistor 232 is turned off and the N-channel field-effect transistors 233 and 234 are turned on. Therefore, the potential of the connection point A becomes a low level and the P-channel field-effect transistor 241 is turned on, so that, as shown in FIG. 5, the voltage corresponding to the input voltage Vin is output as an output voltage Vout via the output buffer 240.

On the other hand, when an overvoltage (for example, voltage of 5 V or more) is input as the input voltage Vin, the gate potential of the P-channel field-effect transistor 232 decreases sufficiently with respect to the source potential, so that the P-channel field-effect transistor 232 is turned on. At this time, the divided voltage of the sixth stage is input to the gates of the N-channel field-effect transistors 233 and 234 and the gate voltage becomes shallow compared with the case where the divided voltage of the third stage is input and the driving force of the N-channel field-effect transistors 233 and 234 is smaller than that of the P-channel field-effect transistor 232. Therefore, the action of raising the potential of the connection point A via the P-channel field-effect transistor 232 works stronger than the action of lowering the potential of the connection point A via the N-channel field-effect transistors 233 and 234, so that the potential of the connection point A becomes a high level. Then, as shown in FIG. 5, the potential of the connection point A is inverted in the output buffer 240, so that the output voltage Vout becomes a low level to be input to the gate of the P-channel field-effect transistor 132 in FIG. 1.

Consequently, an overvoltage input between the power supply wires 111 and 113 in FIG. 1 can be detected and the P-channel field-effect transistor 132 in FIG. 1 can be turned on, so that the gate/source voltage of the P-channel field-effect transistor 131 can be set to 0 V. Because the gate of the P-channel field-effect transistor 131 is in an off-state, the turn-on voltage is high. Therefore, even when the clamp voltage difference VR2−VR1 between the electrostatic protection circuits 121 and 122 becomes large, snapback can be prevented until the turn-on voltage of the P-channel field-effect transistor 131 at the time of gate-off.

Moreover, a plurality of diode-connected P-channel field-effect transistors 221 to 227 is connected in series, so that the reference voltage can be set finely and standby leakage can be reduced.

Furthermore, the P-channel field-effect transistors 231 and 232 and the N-channel field-effect transistors 233 and 234 are connected in series, so that standby leakage can be reduced.

In the example in FIG. 4, the method of connecting the P-channel field-effect transistors 221 to 227 in seven stages is explained, however, N (N is an integer of three or greater) number of diodes connected in series in N stages may be used.

Moreover, in the example in FIG. 4, the method is explained, in which the gate voltage of the P-channel field-effect transistor 232 is controlled based on the divided voltage of the third stage and the gate voltages of the N-channel field-effect transistors 233 and 234 are controlled based on the divided voltage of the sixth stage, however, the gate voltage of the P-channel field-effect transistor 232 may be controlled based on the output of the i-th stage (i is an integer of one or greater and (N-1) or less) and the gate voltages of the N-channel field-effect transistors 233 and 234 may be controlled based on the output of the j-th stage (j is an integer of (i+1) or greater and N or less) among N number of diodes connected in series.

### Second Embodiment

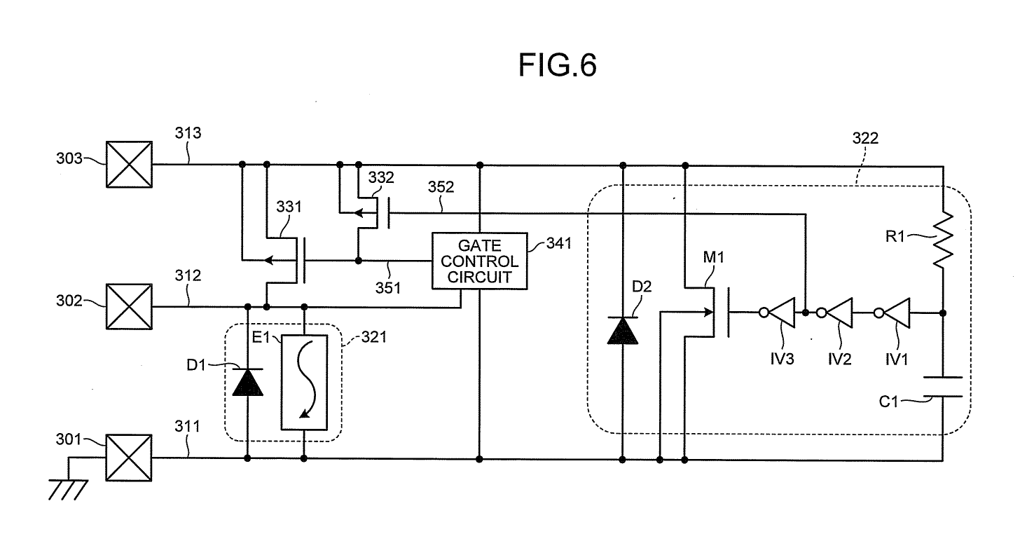

FIG. 6 is a block diagram illustrating a schematic configuration of a voltage conversion circuit according to the second embodiment.

In FIG. 6, a power supply wire 311 that transmits the first voltage V1 is connected to a pad electrode 301, a power supply wire 312 that transmits the second voltage V2 is connected to a pad electrode 302, and a power supply wire 313 that transmits the third voltage V3 is connected to a pad electrode 303.

An electrostatic protection circuit 321 is connected between the power supply wires 311 and 312 and an electrostatic protection circuit 322 is connected between the power supply wires 311 and 313. The electrostatic protection circuit 321 includes the diode D1 and the electrostatic protection element E1 and the electrostatic protection circuit 322 includes the diode D2, an N-channel field-effect transistor M1, inverters IV1 to IV3, a resistor R1, and a capacitor C1. The electrostatic protection circuit 322 is configured by a known method (U.S. Pat. No. 5,239,440).

The N-channel field-effect transistor M1 is connected between the power supply wires 311 and 313. The resistor R1 and the capacitor C1 are connected in series and this RC series circuit is connected between the power supply wires 311 and 313. The connection, point of the resistor R1 and the capacitor, C1 is connected to the gate of the N-channel field-effect transistor M1 via the inverters IV1 to IV3 sequentially.

A P-channel field-effect transistor 331 is connected between the power supply wire 312 and 313 and a P-channel field-effect transistor 332 is connected between the power supply wire 313 and the gate of the P-channel field-effect transistor 331. A gate control circuit 341 is connected to the gate of the P-channel field-effect transistor 331 and the output terminal of the inverter IV2 is connected to the gate of the P-channel field-effect transistor 332. The gate control circuit 341 can control the gate potential of the P-channel field-effect transistor 331 based on the detection result of the second voltage V2.

The second voltage V2 is generated by the third voltage V3 being lowered via the N-channel field-effect transistor 331 and is applied to the power supply wire 312. The voltage of the power supply wire 312 is monitored by the gate control circuit 341 and the gate potential of the N-channel field-effect transistor 331 is controlled so that the voltage of the power supply wire 312 matches the second voltage V2.

The voltage between the power supply wires 311 and 312 is monitored by the electrostatic protection circuit 321, and when an overvoltage is applied between the power supply wires 311 and 312, the electrostatic protection circuit 321 operates, so that the voltage between the power supply wires 311 and 312 is clamped to the clamp voltage VR1.

The voltage between the power supply wires 311 and 313 is monitored by the electrostatic protection circuit 322. When the power supply wire 313 is boosted with respect to the power supply wire 311, the electrostatic protection circuit 322 detects its rising edge and starts a protection operation and the voltage between the power supply wires 311 and 313 is clamped to the clamp voltage VR2.

In the electrostatic protection circuit 322, when the potential difference between the first voltage V1 and the third voltage V3 is a steady state (for example, 3.3 V), the input potential of the inverter IV1 becomes a high level. Therefore, the gate potential of the N-channel field-effect transistor M1 becomes a low level, so that the N-channel field-effect transistor M1 is turned off. When the input potential of the inverter IV1 becomes a high level, the output potential of the inverter IV2 becomes a high level and the P-channel field-effect transistor 332 is turned off, so that the gate of the P-channel field-effect transistor 331 only receives a control signal from the gate control circuit 341 without being affected by the electrostatic protection circuit 322 in the normal operation state.

On the other hand, when an overvoltage is input to the power supply wire 313 and the third voltage V3 becomes large, the input potential of the first voltage V1 follows the third voltage V3 according to the time constant determined by the resistor R1 and the capacitor C1 and the input potential of the inverter IV1 becomes lower than the voltage of the power supply wire 313 during that period. Therefore, the output potential of the inverter IV2 becomes the voltage equivalent to the voltage of the power supply wire 311 and the P-channel field-effect transistor 332 is turned on, so that the gate and the source of the P-channel field-effect transistor 331 are short-circuited. Moreover, when the output potential of the inverter IV2 becomes equivalent to the voltage of the power supply wire 311, the output potential of the inverter IV3 becomes the voltage equivalent to the voltage of the power supply wire 313 and thus the N-channel field-effect transistor M1 is turned on, so that the voltage between the power supply wires 311 and 313 is clamped.

Consequently, the P-channel field-effect transistor 332 can be controlled to be turned on and off based on the internal voltage of the electrostatic protection circuit 322, so that the abnormal voltage detection circuit 142 in FIG. 1 can be omitted, enabling to reduce the chip area.

### Third Embodiment

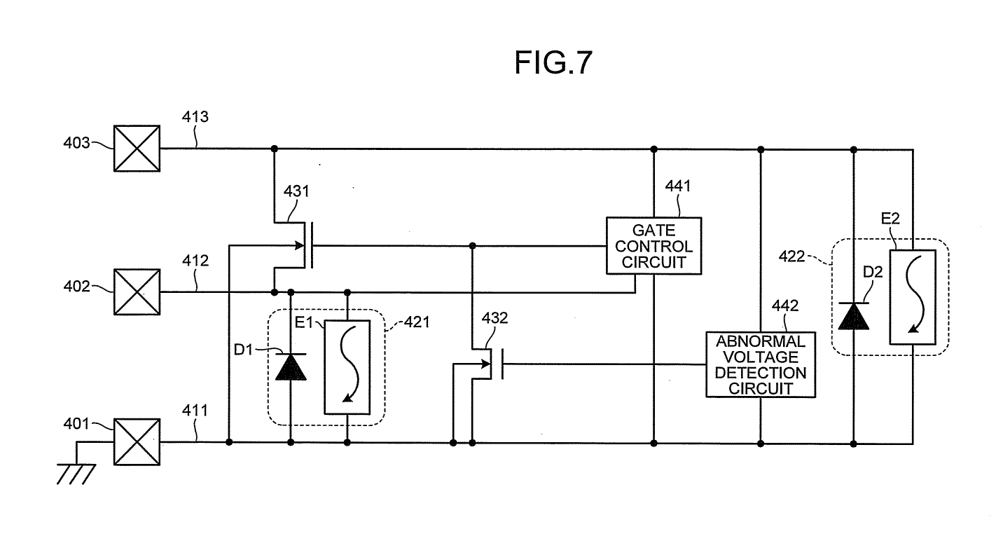

FIG. 7 is a block diagram illustrating a schematic configuration of a voltage conversion circuit according to the third embodiment.

In FIG. 7, a power supply wire 411 that transmits the first voltage V1 is connected to a pad electrode 401, a power supply wire 412 that transmits the second voltage V2 is connected to a pad electrode 402, and a power supply wire 413 that transmits the third voltage V3 is connected to a pad electrode 403.

An electrostatic protection circuit 421 is connected between the power supply wires 411 and 412 and an electrostatic protection circuit 422 is connected between the power supply wires 411 and 413. The electrostatic protection circuit 421 includes the diode D1 and the electrostatic protection element El and the electrostatic protection circuit 422 includes the diode D2 and the electrostatic protection element E2.

An N-channel field-effect transistor 431 is connected between the power supply wire 412 and 413 and an N-channel field-effect transistor 432 is connected between the power supply wire 411 and the gate of the N-channel field-effect transistor 431. A gate control circuit 441 is connected to the gate of the N-channel field-effect transistor 431 and an abnormal voltage detection circuit 442 is connected to the gate of the N-channel field-effect transistor 432.

The gate control circuit 441 can control the gate potential of the N-channel field-effect transistor 431 based on the detection result of the second voltage V2. The abnormal voltage detection circuit 442 can control on and off of the N-channel field-effect transistor 432 based on the potential difference between the first voltage V1 and the third voltage V3.

The second voltage V2 is generated by the third voltage V3 being lowered via the N-channel field-effect transistor 431 and is applied to the power supply wire 412. The voltage of the power supply wire 412 is monitored by the gate control circuit 441 and the gate potential of the N-channel field-effect transistor 431 is controlled so that the voltage of the power supply wire 412 matches the second voltage V2.

The voltage between the power supply wires 411 and 412 is monitored by the electrostatic protection circuit 421, and when an overvoltage is applied between the power supply wires 411 and 412, the electrostatic protection circuit 421 operates, so that the voltage between the power supply wires 411 and 412 is clamped to the clamp voltage VR1.

The voltage between the power supply wires 411 and 413 is monitored by the electrostatic protection circuit 422, and when an overvoltage is applied between the power supply wires 411 and 413, the electrostatic protection circuit 422 operates, so that the voltage between the power supply wires 411 and 413 is clamped to the clamp voltage VR2.

The voltage between the power supply wires 411 and 413 is monitored by the abnormal voltage detection circuit 442. When the voltage between the power supply wires 411 and 413 is equal to or lower than the reference voltage, the gate potential of the N-channel field-effect transistor 432 is maintained in a low level. Therefore, the N-channel field-effect transistor 432 is turned off, so that the gate and the source of the N-channel field-effect transistor 431 are separated. On the other hand, when the voltage between the power supply wires 411 and 413 exceeds the reference voltage, the gate potential of the N-channel field-effect transistor 432 is maintained in a high level. Therefore, the N-channel field-effect transistor 432 is turned on and the gate and the source of the N-channel field-effect transistor 431 are short-circuited.

The reference voltage of the abnormal voltage detection circuit 442 can be set to be larger than the third voltage V3 (for example, 3.3 V) in a steady state and smaller than the turn-on voltage of the N-channel field-effect transistor 431.

Therefore, even when the N-channel field-effect transistor 431 is used as a regulation transistor, the gate and the source of the N-channel field-effect transistor 431 can be short-circuited before reaching the turn-on voltage of the N-channel field-effect transistor 431, so that the ESD resistance of the N-channel field-effect transistor 431 can be improved while suppressing increase in the layout area.

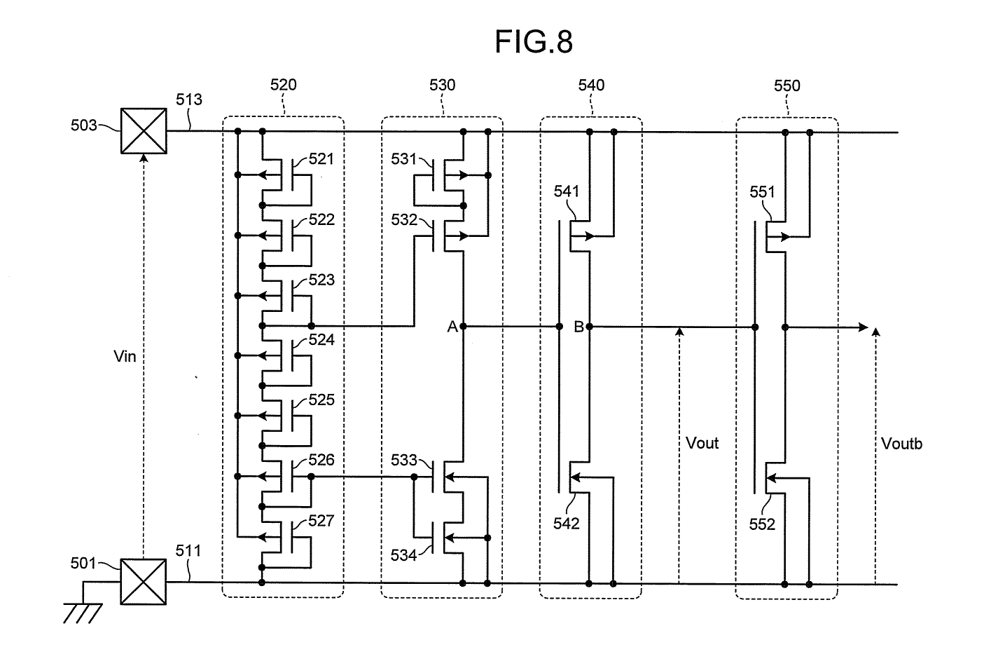

FIG. 8 is a circuit diagram illustrating a configuration example of the abnormal voltage detection circuit in FIG. 7.

In FIG. 8, the abnormal voltage detection circuit 442 includes a reference voltage generating circuit 520, an overvoltage detection circuit 530, and output buffers 540 and 550. The reference voltage generating circuit 520, the overvoltage detection circuit 530, and the output buffer 540 can be configured in the similar manner to the reference voltage generating circuit 220, the overvoltage detection circuit 230, and the output buffer 240 in FIG. 4. The reference voltage generating circuit 520 includes P-channel field-effect transistors 521 to 527. The overvoltage detection circuit 530 includes P-channel field-effect transistors 531 and 532 and N-channel field-effect transistors 533 and 534. The output buffer 540 includes a P-channel field-effect transistor 541 and an N-channel field-effect transistor 542. The output buffer 550 can invert the output of the output buffer 540.

A pad electrode 501 is connected to a power supply wire 511 and a pad electrode 503 is connected to a power supply wire 513. The power supply wire 511 can transmit the first voltage V1 and the power supply wire 513 can transmit the third voltage V3.

The output buffer 550 can be configured in the similar manner to the output buffer 540. The output buffer 550 is connected between the power supply wires 511 and 513.

Specifically, the output buffer 550 includes a P-channel field-effect transistor 551 and an N-channel field-effect transistor 552. The P-channel field-effect transistor 551 and the N-channel field-effect transistor 552 are connected in series. The source of the P-channel field-effect transistor 551 is connected to the power supply wire 513 and the source of the N-channel field-effect transistor 552 is connected to the power supply wire 511. The gates of the P-channel field-effect transistor 551 and the N-channel field-effect transistor 552 are connected to a connection point B of the P-channel field-effect transistor 541 and the N-channel field-effect transistor 542.

In the similar manner to the configuration in FIG. 4, the output voltage Vout is output from the output buffer 540 and the output voltage Vout is inverted in the output buffer 550, so that an output voltage Voutb is generated.

Thus, when an overvoltage is applied to the power supply wire 513, the gate potential of the N-channel field-effect transistor 432 can be set to a high level, so that the N-channel field-effect transistor 432 can be turned on. Therefore, even when the N-channel field-effect transistor 431 is used as a regulation transistor, the voltage between the gate and the source of the N-channel field-effect transistor 431 can be made zero and the turn-on voltage can be made high, so that an overcurrent breakdown due to snapback of the N-channel field-effect transistor 431 can be suppressed.

### Fourth Embodiment

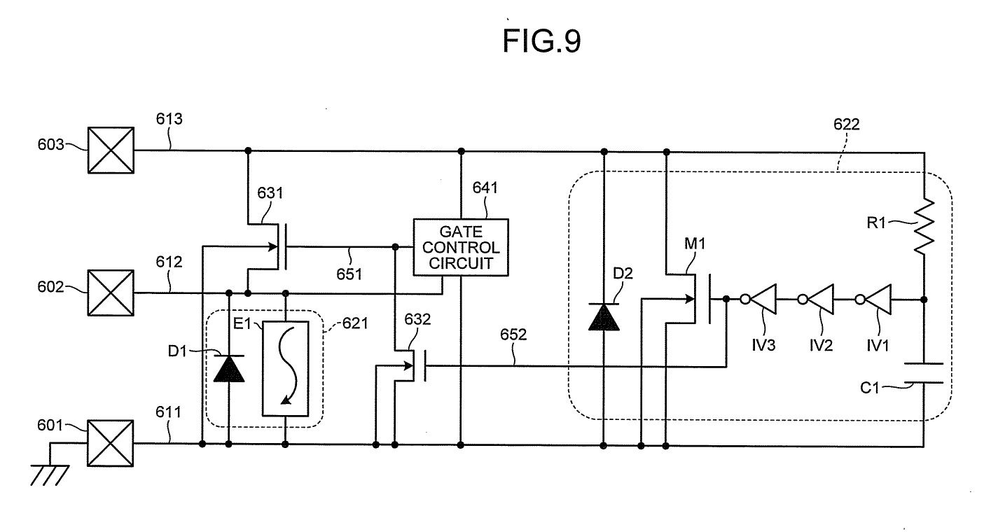

FIG. 9 is a block diagram illustrating a schematic configuration of a voltage conversion circuit according to the fourth embodiment.

In FIG. 9, a power supply wire 611 that transmits the first voltage V1 is connected to a pad electrode 601, a power supply wire 612 that transmits the second voltage V2 is connected to a pad electrode 602, and a power supply wire 613 that transmits the third voltage V3 is connected to a pad electrode 603.

An electrostatic protection circuit 621 is connected between the power supply wires 611 and 612 and an electrostatic protection circuit 622 is connected between the power supply wires 611 and 613. The electrostatic protection circuit 621 can be configured in the similar manner to the electrostatic protection circuit 321 in FIG. 6. The electrostatic protection circuit 622 can be configured in the similar manner to the electrostatic protection circuit 322 in FIG. 6.

An N-channel field-effect transistor 631 is connected between the power supply wires 612 and 613 and an N-channel field-effect transistor 632 is connected between the power supply wire 613 and the gate of the N-channel field-effect transistor 631. A gate control circuit 641 is connected to the gate of the N-channel field-effect transistor 631 and the output terminal of the inverter IV3 is connected to the gate of the N-channel field-effect transistor 632. The gate control circuit 641 can control the gate potential of the N-channel field-effect transistor 631 based on the detection result of the third voltage V3.

The second voltage V2 is generated by the third voltage V3 being lowered via the N-channel field-effect transistor 631 and is applied to the power supply wires 612. The voltage of the power supply wires 612 is monitored by the gate control circuit 641 and the gate potential of the N-channel field-effect transistor 631 is controlled so that the voltage of the power supply wires 612 matches the second voltage V2.

The voltage between the power supply wires 611 and 612 is monitored by the electrostatic protection circuit 621, and when an overvoltage is applied between the power supply wires 611 and 612, the electrostatic protection circuit 621 operates, so that the voltage between the power supply wires 611 and 612 is clamped to the clamp voltage VR1.

The voltage between the power supply wires 611 and 613 is monitored by the electrostatic protection circuit 622, and when an overvoltage is applied between the power supply wires 611 and 613, the electrostatic protection circuit 622 operates, so that the voltage between the power supply wires 611 and 613 is clamped to the clamp voltage VR2.

In the electrostatic protection circuit 622, when the potential difference between the first voltage V1 and the third voltage V3 is a steady state (for example, 3.3 V), the input potential of the inverter IV1 becomes a high level. Therefore, the gate potential of the N-channel field-effect transistor M1 becomes a low level, so that the N-channel field-effect transistor M1 is turned off. When the input potential of the inverter IV1 becomes a high level, the output potential of the inverter IV3 becomes a low level and thus the N-channel field-effect transistor 632 is turned off, so that the gate and the source of the N-channel field-effect transistor 631 are separated.

On the other hand, when an overvoltage is input to the power supply wire 613 and the third voltage V3 becomes large, the input potential of the first voltage V1 follows the third voltage V3 according to the time constant determined by the resistor R1 and the capacitor C1 and the input potential of the inverter IV1 becomes lower than the voltage of the power supply wire 613 during that period. Therefore, the output potential of the inverter IV3 becomes the voltage equivalent to the voltage of the power supply wires 611 and the N-channel field-effect transistor 632 is turned on, so that the gate and the source of the N-channel field-effect transistor 631 are short-circuited. Moreover, when the output potential of the inverter IV3 becomes the voltage equivalent to the voltage of the power supply wires 611, the N-channel field-effect transistor M1 is turned on, so that the voltage between the power supply wires 611 and 613 is clamped.

Consequently, the N-channel field-effect transistor 632 can be controlled to be turned on and off based on the internal voltage of the electrostatic protection circuit 622, so that the abnormal voltage detection circuit 442 in FIG. 7 can be omitted, enabling to reduce the chip area.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor integrated circuit comprising:
a first power supply wire that transmits a first voltage;
a second power supply wire that transmits a second voltage higher than the first voltage;
a third power supply wire that transmits a third voltage higher than the second voltage;
a first electrostatic protection circuit connected between the first power supply wire and the second power supply wire;
a second electrostatic protection circuit connected between the first power supply wire and the third power supply wire;
a first transistor connected between the second power supply wire and the third power supply wire;
a gate control circuit that controls a gate potential of the first transistor based on a detection result of the second voltage;
a second transistor connected between the third power supply wire and a gate of the first transistor; and
an abnormal voltage detection circuit that controls on and off of the second transistor based on a detection result of the third voltage.

2. The semiconductor integrated circuit of claim 1, wherein when the third voltage becomes an overvoltage, the second transistor makes a gate and a source of the first transistor to be short-circuited before reaching a turn-on voltage of the first transistor.

3. The semiconductor integrated circuit of claim 1, wherein
the first electrostatic protection circuit includes
a first diode connected between the first power supply wire and the second power supply wire, and
a first electrostatic protection element which is connected between the first power supply wire and the second power supply wire and in which a polarity responding to an overcurrent is different from the first diode, and
the second electrostatic protection circuit includes
a second diode connected between the first power supply wire and the third power supply wire, and
a second electrostatic protection element which is connected between the first power supply wire and the third power supply wire in which a polarity responding to an overcurrent is different from the second diode.

4. The semiconductor integrated circuit of claim 1, wherein a clamp voltage of the second electrostatic protection circuit is higher than a clamp voltage of the first electrostatic protection circuit.

5. The semiconductor integrated circuit of claim 1, wherein
the abnormal voltage detection circuit includes
a reference voltage generating circuit that generates a reference voltage by dividing the third voltage,
an overvoltage detection circuit that detects an overvoltage based on the reference voltage, and
an output buffer that inverts an output of the overvoltage detection circuit.

6. The semiconductor integrated circuit of claim 5, wherein
the reference voltage generating circuit includes N (N is an integer of three or greater) number of diodes connected in series in N stages,
the overvoltage detection circuit includes
a P-channel field-effect transistor whose gate voltage is controlled based on an output of an i-th (i is an integer of one or greater and (N-1) or less) stage of the diodes, and
an N-channel field-effect transistor which is connected in series with the P-channel field-effect transistor and whose gate potential is controlled based on an output of j-th (j is an integer of (i+1) or greater and N or less) stage of the diodes, and
the output buffer includes an inverter that inverts a potential at a connection point of the P-channel field-effect transistor and the N-channel field-effect transistor.

7. The semiconductor integrated circuit of claim 6, wherein
the P-channel field-effect transistor is a plurality of P-channel field-effect transistors connected in series, and
the N-channel field-effect transistor is a plurality of N-channel field-effect transistors connected in series.

8. The semiconductor integrated circuit of claim 6, wherein a driving force of the P-channel field-effect transistor is larger than that of the N-channel field-effect transistor.

9. A semiconductor integrated circuit comprising:
a first power supply wire that transmits a first voltage;
a second power supply wire that transmits a second voltage higher than the first voltage;
a third power supply wire that transmits a third voltage higher than the second voltage;
a first electrostatic protection circuit connected between the first power supply wire and the second power supply wire;
a second electrostatic protection circuit connected between the first power supply wire and the third power supply wire;
a first transistor connected between the second power supply wire and the third power supply wire;
a gate control circuit that controls a gate potential of the first transistor based on a detection result of the second voltage; and
a second transistor that is connected between the third power supply wire and a gate of the first transistor and is controlled to be turned on and off based on an internal voltage of the second electrostatic protection circuit.

10. The semiconductor integrated circuit of claim 9, wherein when the third voltage becomes an overvoltage, the second transistor makes a gate and a source of the first transistor to be short-circuited before reaching a turn-on voltage of the first transistor.

11. The semiconductor integrated circuit of claim 9, wherein
the first electrostatic protection circuit includes
a first diode connected between the first power supply wire and the second power supply wire, and
a first electrostatic protection element which is connected between the first power supply wire and the second power supply wire and in which a polarity responding to an overcurrent is different from the first diode.

12. The semiconductor integrated circuit of claim 9, wherein
the second electrostatic protection circuit includes
an RC series circuit connected between the first power supply wire and the third power supply wire, and
a third transistor which is connected between the first power supply wire and the third power supply wire and is controlled to be turned on and off based on a potential at a connection point of a resistor and a capacitor of the RC series circuit, and
the internal voltage is generated based on the potential at the connection point of the resistor and the capacitor of the RC series circuit.

13. The semiconductor integrated circuit of claim 12, wherein the second electrostatic protection circuit includes a second diode connected between the first power supply wire and the third power supply wire.

14. The semiconductor integrated circuit of claim 13, wherein the second electrostatic protection circuit includes an inverter inserted between the connection point of the resistor and the capacitor of the RC series circuit and a gate of the third transistor.

15. A semiconductor integrated circuit comprising:
a first power supply wire that transmits a first voltage;
a second power supply wire that transmits a second voltage higher than the first voltage;
a third power supply wire that transmits a third voltage higher than the second voltage;
a first electrostatic protection circuit connected between the first power supply wire and the second power supply wire;
a second electrostatic protection circuit connected between the first power supply wire and the third power supply wire;
a first transistor connected between the second power supply wire and the third power supply wire;
a gate control circuit that controls a gate potential of the first transistor based on a detection result of the second voltage; and
a second transistor that is connected between the third power supply wire and a gate of the first transistor and makes a gate and a source of the first transistor to be short-circuited before reaching a turn-on voltage of the first transistor.

16. The semiconductor integrated circuit of claim 15, further comprising an abnormal voltage detection circuit that controls on and off of the second transistor based on a detection result of the third voltage.

17. The semiconductor integrated circuit of claim 16, wherein
the abnormal voltage detection circuit includes
a reference voltage generating circuit that generates a reference voltage by dividing the third voltage,
an overvoltage detection circuit that detects an overvoltage based on the reference voltage, and
an output buffer that inverts an output of the overvoltage detection circuit.

18. The semiconductor integrated circuit of claim 17, wherein
the reference voltage generating circuit includes N (N is an integer of three or greater) number of diodes connected in series in N stages,
the overvoltage detection circuit includes
a P-channel field-effect transistor whose gate voltage is controlled based on an output of an i-th (i is an integer of one or greater and (N-1) or less) stage of the diodes, and
an N-channel field-effect transistor which is connected in series with the P-channel field-effect transistor and whose gate potential is controlled based on an output of j-th (j is an integer of (i+1) or greater and N or less) stage of the diodes, and
the output buffer includes an inverter that inverts a potential at a connection point of the P-channel field-effect transistor and the N-channel field-effect transistor.

19. The semiconductor integrated circuit of claim 16, wherein the second transistor is controlled to be turned on and off based on an internal voltage of the second electrostatic protection circuit.

20. The semiconductor integrated circuit of claim 19, wherein
the first electrostatic protection circuit includes
a first diode connected between the first power supply wire and the second power supply wire, and
a first electrostatic protection element which is connected between the first power supply wire and the second power supply wire and in which a polarity responding to an overcurrent is different from the first diode, and
the second electrostatic protection circuit includes
an RC series circuit connected between the first power supply wire and the third power supply wire, and
a third transistor which is connected between the first power supply wire and the third power supply wire and is controlled to be turned on and off based on a potential at a connection point of a resistor and a capacitor of the RC series circuit, and
the internal voltage is generated based on the potential at the connection point of the resistor and the capacitor of the RC series circuit.
